(19) United States
(12) Patent Application Publication
(10) Pub. No.: US 2014/0032316 A1
(43) Pub. Date: Jan. 30, 2014

(54) VOLUME BAR ADVERTISING

(71) Applicant: Specific Media LLC, Irvine, CA (US)

(72) Inventors: Steven Michael Cormie, Cambridge (GB); Brian Jentz, Calstone Wellington (GB)

(73) Assignee: Specific Media LLC, Irvine, CA (US)

(21) Appl. No.: 13/954,665

(22) Filed: Jul. 30, 2013

Related U.S. Application Data
(60) Provisional application No. 61/677,280, filed on Jul. 30, 2012.

(51) Int. Cl. G06Q 30/02

(52) U.S. Cl. CPC G06Q 30/0251
USPC 705/14.49

(57) ABSTRACT

A method, apparatus, system, and computer program product provide the ability to deliver an advertisement to a user. Audio content is played for/to a user. Volume user input is received from the user. The volume user input is an adjustment of a volume of the audio content. In response to the volume user input, a volume bar indicating a volume level for the audio content is displayed as well as an advertisement that is based on the volume bar.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/677,280, filed on Jul. 30, 2012, by Steve Cormie and Brian Jentz, entitled “Television Volume Bar Advertising,” attorneys' docket number 257.65-US-P1.

### BACKGROUND OF THE INVENTION

1. Field of the Invention

The present invention relates generally to television/video advertising, and in particular, to a method, apparatus, and article of manufacture for displaying/delivering advertisements to a user while the user is interacting with a volume control.

2. Description of the Related Art

Audio/video media content is consumed by users via a plethora of different hardware platforms in a variety of different formats. Furthermore, such audio/video media content is delivered to such users using a variety of different delivery mechanisms (e.g., broadcast, multicast, unicast, etc.). Regardless of the hardware platform or format, it is often desirable for the content owner, broadcaster, hardware owner, etc. to monetize the delivery and/or consumption of the media content. Advertising is a predominately used mechanism for monetization. Both advertisers and those desiring to monetize the media content delivery/consumption often seek new and creative ways to deliver/display advertising to users/consumers. While existing advertising mechanisms are plentiful, it is always desirable to further improve and find new/unique ways to deliver/display advertising to users.

### SUMMARY OF THE INVENTION

Embodiments of the invention provide a new/unique way to display advertising to users/consumers. When a user presses the volume up/down (e.g., on a remote control, other suitable device, or directly on the media content delivery hardware [e.g., television, display monitor, cellular phone, automobile display, etc.]) an advertisement is displayed.

### BRIEF DESCRIPTION OF THE DRAWINGS

Referring now to the drawings in which like reference numbers represent corresponding parts throughout:

FIG. 1 is an exemplary hardware and software environment/platform used to implement one or more embodiments of the invention;

FIG. 2 illustrates the interaction between different components of the system/platform;

FIG. 3 illustrates an exemplary embodiment with a banner advertisement integrated into a volume bar in accordance with one or more embodiments of the invention;

FIG. 4 illustrates an alternative placement of an advertisement adjacent to the volume bar in accordance with one or more embodiments of the invention; and

FIG. 5 illustrates the logical flow for delivering an advertisement to a user in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

When a user/consumer is adjusting the volume for audio, an advertisement is displayed during such adjusting.

### Hardware Environment

As used herein, “media content” refers to audio, audio-video, and/or any other content that has an acoustic/audio component. As described above, a variety of different hardware platforms may be utilized to deliver and view media content. Embodiments of the invention are intended to apply to all and/or a subset of such platforms. Several exemplary platforms are described herein but the invention is not limited to such platforms.

It may be useful to note that as used herein, the hardware platform includes several components: (1) the screen/monitor/display on which media content is viewed (referred to as “display device”); (2) the hardware that receives the media content from a source and formats/delivers the content to the display device (referred to as a “media receiver”); and (3) the transmission mechanism/distribution system for the media content. It may also be noted that the functionality performed by each of the components may at times be performed by other components in the hardware platform. In addition, the components may be integrated together. For example, the display device may be integrated into and part of the media receiver.

Embodiments of the invention may be utilized in the context of television viewing but may also apply to any device that has a volume control including cellular devices (e.g., cellular phones), personal digital assistants (PDAs), tablet computers (e.g., the iPad™ tablet), music players (e.g., MP3 players such as iPod™ music players), automobile displays (e.g., center console display), etc.

In the context of television/media viewing, the display device may consist of traditional television display devices (e.g., LED [light emitting diode] televisions, plasma televisions, LCD [liquid crystal display], cathode ray tube [CRT] displays). Such traditional display devices may receive the media content directly from a broadcast source (e.g., via an integrated antenna or via cable, wireless network, etc.) wherein the tuner/receiver is integrated into the display device. Alternatively, the display device may be connected to a tuner/receiver (e.g., a set top box) that receives the content, decodes the content, etc. for display on the display device. Such a set top box (STB) may receive the content via satellite, cable, broadcast, etc.

In one or more embodiments of the invention, the media content may be viewed on a display device that receives the media content via the Internet or broadband connection. In such an embodiment, the display device may be a computer monitor that receives the content from a computer via a user's broadband connection (e.g., to the Internet). Alternatively, the television itself may be “connected” to the Internet such that it is Internet-enabled. In alternative embodiments, the receiver that delivers content to a display device may consist of hardware/media player specifically directed towards television viewing (e.g., via a broadband connection). Examples of such devices include a Boxee device, an AppleTV™ device, a Google™ set-top box, a Roku™ television device, etc. In yet another embodiment, the display device may consist of a cellular device/phone that receives media content via a cellular network.

Regardless of the display device utilized, the common component across all such display devices is each display device is configured with a volume control. Such a volume control may be on the display device itself (e.g., a physical button or a software enabled volume control) or may be via a remote control or other suitable device. The remote control may be a separate hardware hand-held remote control device or may be an ear-bud type device. For example, embodiments of the invention may consist of a blue-tooth headset with a volume control that communicates (e.g., via short-wavelength radio transmissions) with a separate device that displays media content (e.g., a cellular phone). As used herein, the volume control (whether integrated with or independent from the display device) may be referred to as a volume control device.

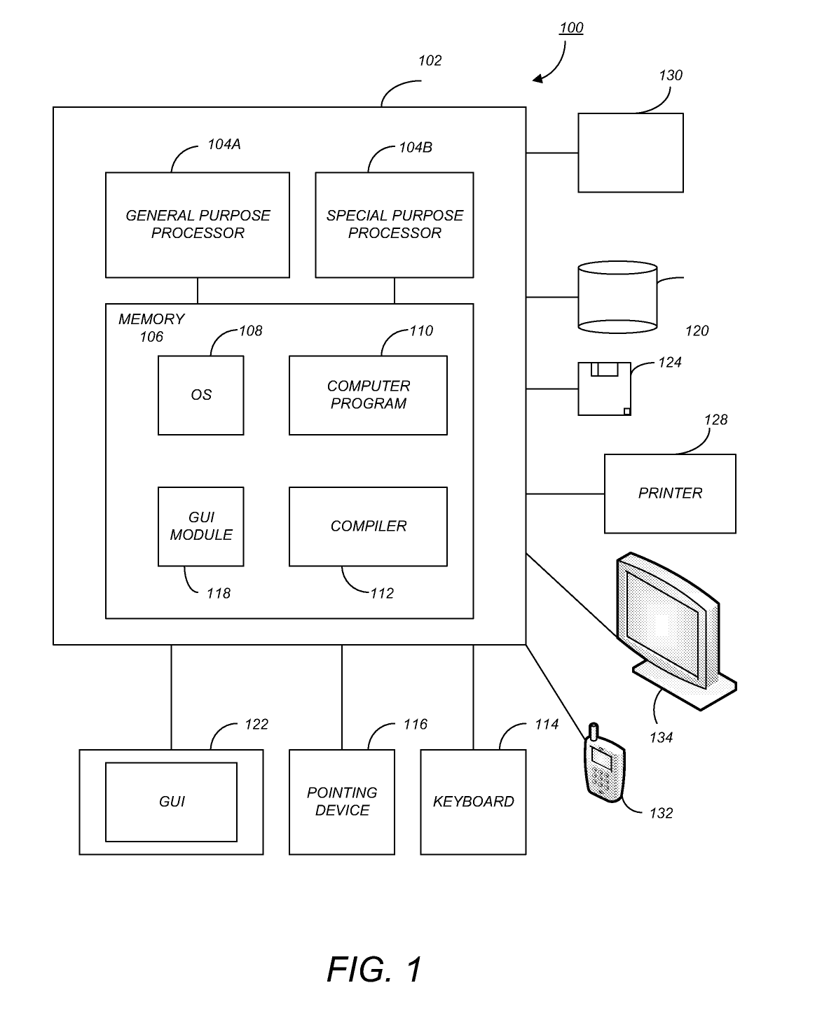

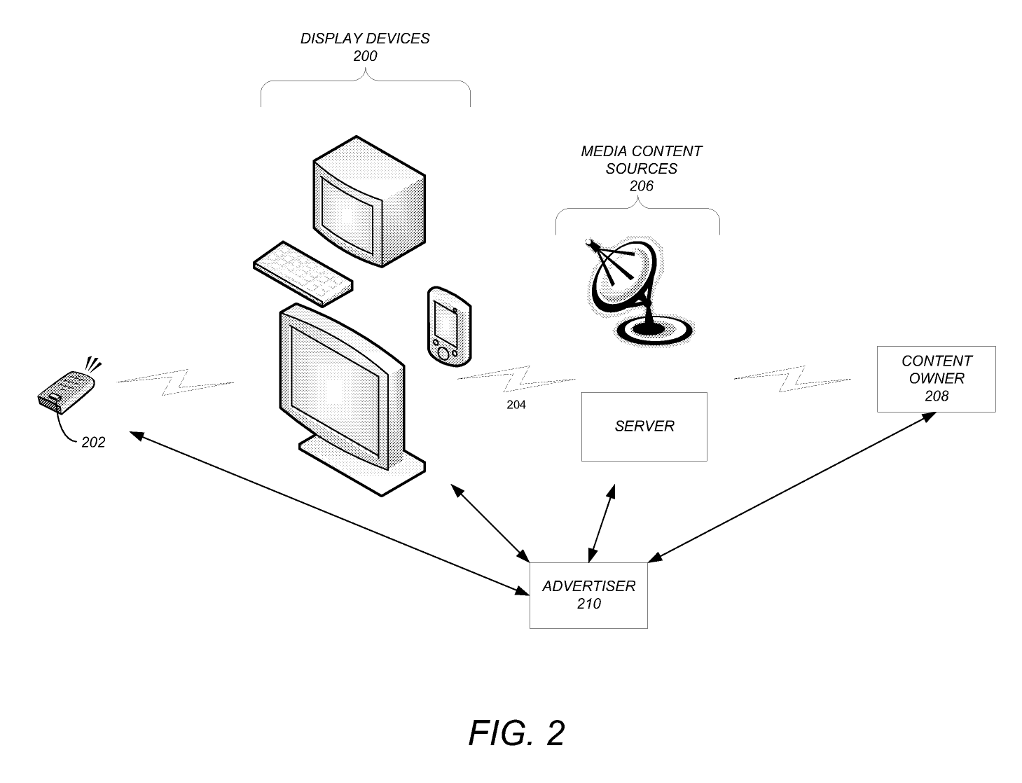

While embodiments of the invention may be utilized in a variety of contexts and hardware platforms, as described above, exemplary platforms are illustrated in FIGS. 1 and 2.

FIG. 1 is an exemplary hardware and software environment/platform 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128.

In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television 134, television set top box, or other internet enabled device 134 executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device (e.g., device 134) for presentation or further processing or action. In one embodiment, the display 122/134 comprises a liquid crystal display (LCD) having a plurality of separately addressable liquid crystals. Alternatively, the display 122/134 may comprise a light emitting diode (LED) display having clusters of red, green and blue diodes driven together to form full-color pixels. Each liquid crystal or pixel of the display 122/134 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122/134 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs). Alternatively, display 122/134 may consist of a television display device that has a built in tuner/receiver or is connected to a set-top-box configured to receive media content.

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and/or providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

FIG. 2 illustrates the interaction between different components of the system/platform. As illustrated, display devices 200 are used to display the media content. Such display devices 200 include cellular devices, television monitors, computers, computer monitors, etc. The volume of the audio on such display devices is controlled via remote control 202 or other suitable device. As described above, the remote control may take the form of a Bluetooth headset, a PDA with wireless communication capabilities, or other device that is capable of communicating with display devices 200 to control the volume of such devices. Alternatively, the volume control may be integrated into such display devices 200 (e.g., via physical volume control buttons, touch screen icons for touch screen devices, etc.).

The display devices 200 receive the media content across network 204 from media content sources 206. Network 204 may consist of a cellular network, satellite network, broadband network, or any type of network capable of transmitting media content. Such media content sources 206 may include broadcasters (e.g., one of the broadcast networks), media content providers (e.g., a cable provider such as Comcast™, satellite provider such as DirecTV™, etc.), computers (e.g., a server or other computer connected to display devices 200 and/or configured to receive content and deliver such content to display devices 200). Further, such computers may be configured to utilize a media player (e.g., Windows™ Media Player™, Quicktime™, etc.) to display media content on a display device 200.

Media content sources 206 may receive such content from content owners 208 (e.g., movie/television studios, private individuals, record companies, etc.).

Advertisements that are displayed in accordance with embodiments of the invention are received from advertiser 210. Advertiser 210 may communicate/transmit advertisements to any of the entities involved (e.g., content owner 208, media content sources 206, and/or display devices 200). As used herein, an advertiser may be an actual advertiser, an advertising network (e.g., Specific Media), an advertising exchange, an advertising server, or any system or combination of systems that delivers an advertising creative to another system or device. In yet another embodiment, remote control 202 may also have display capabilities, and advertisements may be displayed on remote control 202 as well.

When advertiser 210 communicates with media content sources 206, the advertiser 210 may negotiate with media content sources 206 to determine the cost, length of time, etc. for placement of an advertisement. Thereafter, the advertisement may be inserted by media content sources 206 into the media content. Alternatively, a placeholder may be specified in the media content with the advertisement delivered to display devices 200 for delivery to the user/consumer. Consequently, advertisements may be integrated into the media content or may be delivered separately from such media content. Further, in different embodiments, each component (e.g., the content owner 208, media content sources 206, and/or display devices 200) may have the ability to control the advertisement that is displayed/delivered to a user/consumer.

### Volume Bar Advertisement

The basic concept is that whenever the user presses the volume up/down on their remote control 202 or display device 200, a volume bar appears on the display device 200. Incorporated into the volume bar is a display advertisement. Such an advertisement may be a banner advertisement, an icon, an interactive widget, etc. There are various options that may be configurable for the volume bar advertisement. Options for the volume bar advertisement may include any (or none) of the following:
the location of the advertisement;
the duration of the display of the advertisement
the size of the advertisement;
the frequency for modification of the volume bar advertisement;
etc.

Embodiments of the invention may further provide the ability for a user or other administrator to modify such options.

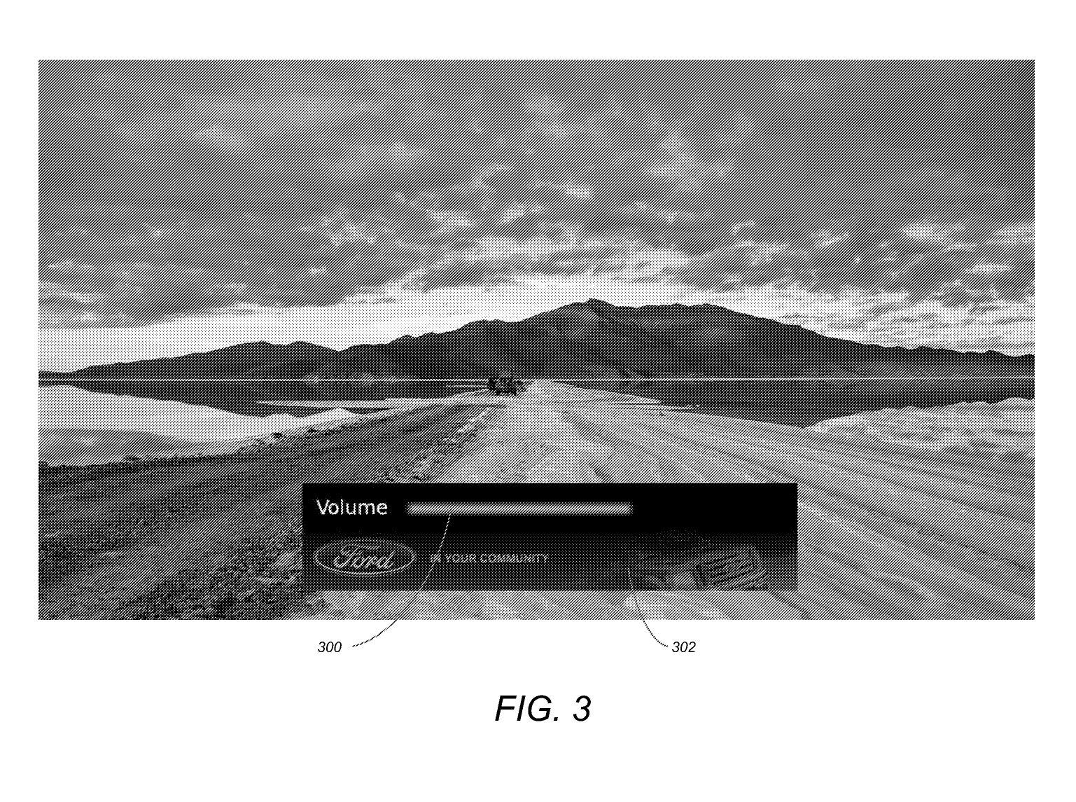

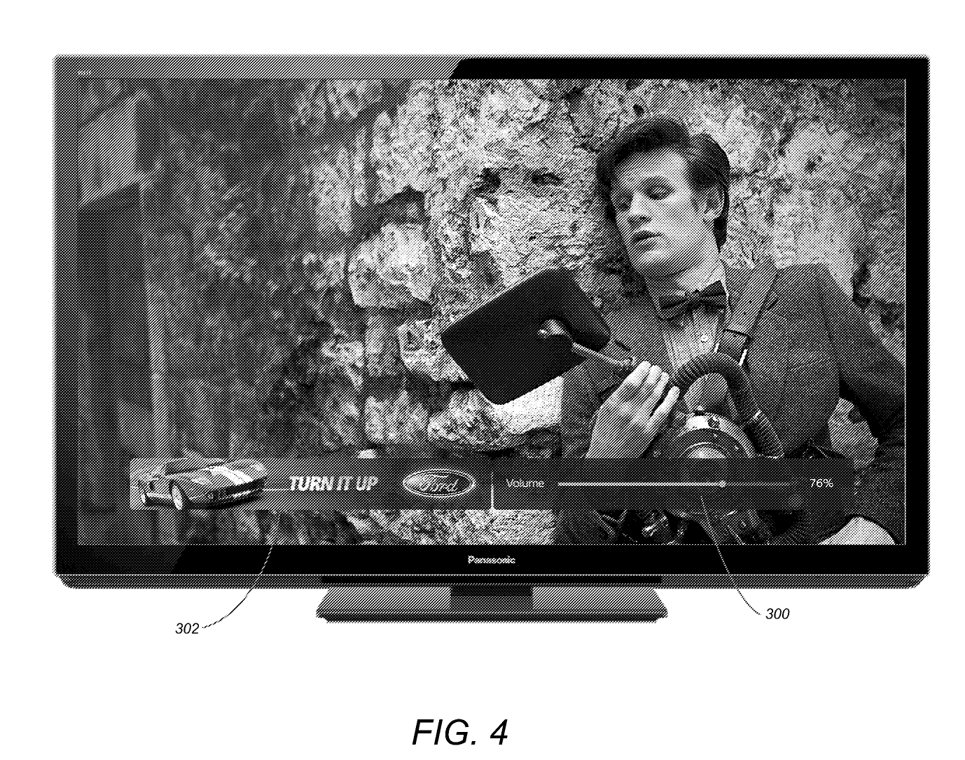

With respect to the location of the advertisement, the advertisement may be displayed integrated with the volume bar. For example, the advertisement may be displayed directly below the volume bar. FIG. 3 illustrates an exemplary embodiment with a banner advertisement integrated into a volume bar in accordance with one or more embodiments of the invention. As illustrated, when the user adjusts the volume of the media content, the volume bar 300 is displayed. Integrated into the volume bar 300 is the advertisement 302 that is displayed directly below the volume bar 300. As an alternative to being displayed directly below the volume bar 300, the advertisement 302 may be displayed adjacent (sideways) to the volume bar 300, or above the volume bar 300. In yet another embodiment, the location of the advertisement 302 can be anywhere within the display area (e.g., upper right left corner). FIG. 4 illustrates an alternative placement of an advertisement 302 where it is adjacent to the volume bar 300. The advertisement 302 of FIG. 4 is not visually integrated with the volume bar 300 as indicated by the space between advertisement 302 and volume bar 300. However, the advertisement 302 is technically integrated with the volume bar 300 based on its size, location, and determination of when it is displayed.

In one or more embodiments, a determination may be made regarding where the advertisement 302 would be the most visible and/or most visible yet not interfere with the user's viewing/interaction with the media content. For example, a determination may be made that the advertisement 302 consists of dark colors. Such coloring may be compared to images of the media content that are displayed to determine the best location for such content. In FIG. 3, a dark advertisement 302 may be the most visible in the upper left corner of the media content and such a determination could result in the placement of the advertisement 302 at such a location. Alternatively, such a determination may result in a finding that placement in the upper left corner would interfere with the user's viewing of the media content and thereby select an alternative location. In yet another embodiment, the coloring, transparency, or other attribute of the advertisement 302 that is displayed may be dynamically changed based on a variety of factors. For example, if multiple advertisements 302 for the same product are available in different colors, an advertisement 302 with a particular coloring scheme may be selected based on the media content over which the advertisement 302 is being displayed (or based on other factors provided by an advertisement selection methodology).

Regardless of the placement/location of the advertisement 302, embodiments of the invention activate the display of the advertisement 302 based upon a user's interaction with the volume of the media content being displayed/played. Such an activation and display of an advertisement 302 may occur regardless of whether the media content is currently being played, whether the playback is paused, or whether the media content has been selected. In other words, the volume control may be solely based on the hardware/media player and may be modified by the user before, during, or after media content has been selected, loaded, played, paused, deleted, etc.

An additional option is that of the length of time in which the advertisement 302 is displayed. Advertisement 302 may be displayed only while the volume is physically being adjusted by the user (e.g., while the user has the volume controls depressed/selected). Alternatively, the advertisement 302 may be displayed while the volume bar 300 is displayed. In yet another embodiment, the advertisement 302 may be displayed for a time period longer than the display of the volume bar (e.g., a fraction of a second, one second, several seconds, until a user selects the advertisement 302, etc.).

The size of the advertisement 302 may also be adjustable/modifiable. For example, the advertisement 302 may be adjusted to be the same size as the volume bar 300, slightly smaller, slightly larger, a small/medium/large icon, etc. In one or more embodiments, the size of the advertisement 302 itself may vary/change. For example, the advertisement 302 may progressively decrease in size or fade until it is no longer displayed (thereby interfering with the viewing of the media content in a progressively decreasing manner). Alternatively, the advertisement 302 may progressively decrease in size/fade away from the volume bar 300, the longer the volume bar is displayed. In this regard, if the volume bar 300 is permanently displayed or is configured to remain active within the media player, the advertisement 302 may only be displayed temporarily within the volume control.

As described above, the advertisement 302 that is displayed with the volume bar 300 may be periodically modified. The frequency for how often the advertisement changes may also be defined. For example, the advertisement 302 that is selected may only be presented to the user at a defined interval (e.g., every time, every other time, every third time, etc. that the volume bar 300 is displayed). Alternatively, an advertisement 302 may only be displayed at the defined intervals and interspersed with other advertisements 302 or no advertisements 302. Rather than specifying an interval, a period of time may also be specified/defined (e.g., one advertisement 302 every ten minutes). Such a definition may also utilize the number and frequency with which the volume control is adjusted (e.g., once every ten minutes if the user adjusts the volume more than three time within the ten minutes).

As described above, a variety of different options and configurations may be available for both the frequency, display time, location, selection, etc. of an advertisement 302 that is displayed based on the adjustment of the audio volume 300. Different options may also be available beyond those described herein.

In addition to the above, the advertisement 302 may have a “click-through” action where the user presses another button on the remote control (or touch screen device), while the volume bar is still displayed, and the user is taken to a “micro-site” where more information about the product can be seen, videos can be played, product can be purchased, etc. Thus, the activation of the secondary remote control button, serves to deliver the user to a website or other location where further promotional activities relating to the advertised product/service may be available. Such an activation of a secondary (or another button) may also serve to deliver the user to a micro-site where the properties/options for the display of the advertisements may be adjusted/modified.

To enable the display of the advertisements 302 during adjustment of the volume, embodiments of the invention may store one or more advertisements 302 in cache or memory that is directly accessible by the display device. For example, an internet enabled television may have memory or other storage where a banner advertisement 302 is stored and retrieved from such that the advertisement 302 is readily available. Such advertisements 302 may be delivered synchronously with or asynchronously from the media content.

In one or more embodiments, the advertisement 302 is accompanied by/transmitted with metadata that identifies the options/properties/type (e.g., volume bar based advertisement) of advertisement 302. Such an advertisement and/or metadata may be transmitted within the blanking interval or ancillary data space of a broadcast (analog or digital) signal. Such metadata may provide the ability to determine the storage, placement, and use of the advertisement 302 desired by the media content source, media content owner, and/or advertiser.

### Logical Flow

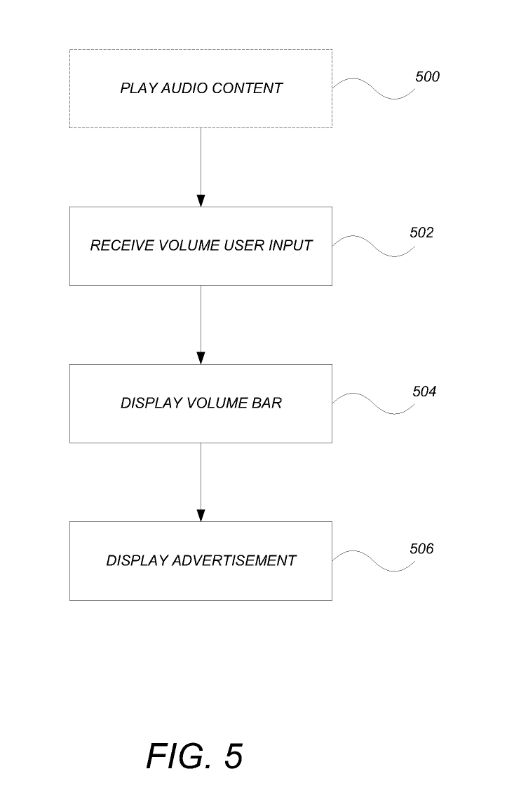

FIG. 5 illustrates the logical flow for delivering an advertisement to a user in accordance with one or more embodiments of the invention. Alternative logic may also be utilized in accordance with one or more embodiments of the invention.

At optional step 500, audio content is played to a user. The audio content is played as part of audio-video media content. Alternatively, audio content does not need to be played prior to modification of the volume at step 502. For example, televisions, tablets, and smart phones can all have the volume changed regardless of whether content is playing.

At step 502, volume user input is received from the user. Volume user input is an adjustment of a volume of the audio content (e.g., via a television remote control).

At step 504, a volume bar (e.g., a volume bar graphical user interface control) indicating a volume level for the audio content is displayed. Such a volume bar may be displayed in response to the volume user input.

Step 506 is performed in response to the receipt of the volume user input. At step 506, an advertisement that is based on the volume bar is displayed. Such an advertisement may be integrated into the volume bar and may comprise a banner advertisement (or other type of advertisement or widget). The advertisement may only be displayed while the volume bar is displayed or may persist for some configurable time period after the volume bar is dispelled. Alternatively, the advertisement may only be displayed while the volume user input is being received (e.g., while the volume up/down button is depressed).

In addition, step 506 may also include the step of receiving user input (e.g., via a button of a remote control) selecting the advertisement. In response to the advertisement selection, a connection may be established between the user and a micro-site (that presents information about a product/service of the advertisement).

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for delivering an advertisement to a user, comprising:
receiving volume user input from the user, wherein the volume user input comprises an adjustment of a volume of audio content;
displaying a volume bar indicating a volume level for the audio content; and
in response to the volume user input:
displaying an advertisement that is based on the volume bar.

2. The method of claim 1, wherein the audio content is played as part of audio-video media content.

3. The method of claim 1, wherein the volume user input is received via a television remote control.

4. The method of claim 1, wherein the advertisement is integrated into the volume bar.

5. The method of claim 1, wherein the advertisement comprises a banner advertisement.

6. The method of claim 1, wherein the advertisement is only displayed while the volume bar is displayed.

7. The method of claim 1, further comprising:
receiving user input selecting the advertisement; and
in response to the user input selecting the advertisement, establishing a connection between the user and a micro-site, wherein the microsite presents information about a product/service of the advertisement.

8. The method of claim 7, wherein the user input selecting the advertisement comprises a selection of a button on a remote control.

9. A system for delivering an advertisement to a user, comprising:
a volume control device for receiving volume user input from the user, wherein the volume user input comprises an adjustment of a volume of audio content;
a display device for displaying a volume bar indicating a volume level for the audio content, wherein in response to the volume user input, an advertisement that is based on the volume bar is displayed on the display device.

10. The system of claim 9, wherein the audio content is played as part of audio-video media content.

11. The system of claim 9, wherein the volume control device comprises a television remote control.

12. The system of claim 9, wherein the advertisement is integrated into the volume bar.

13. The system of claim 9, wherein the advertisement comprises a banner advertisement.

14. The system of claim 9, wherein the advertisement is only displayed while the volume bar is displayed.

15. The system of claim 9, wherein:
the volume control device is further configured to receive user input selecting the advertisement; and
in response to the user input selecting the advertisement, a connection is established between the user and a micro-site, wherein the microsite presents information about a product/service of the advertisement.

16. The system of claim 15, wherein:
the volume control device comprises a remote control; and
the user input selecting the advertisement comprises a selection of a button on the remote control.
